(19) United States
(12) Patent Application Publication
(10) Pub. No.: US 2013/0045455 A1
(43) Pub. Date: Feb. 21, 2013

(54) SELF-LIGATING ORTHODONTIC BRACKET WITH FLEXIBLE LIGATING SLIDE

(71) Applicant: Farrokh Farzin-Nia, Inglewood, CA (US)

(72) Inventor: Farrokh Farzin-Nia, Inglewood, CA (US)

(21) Appl. No.: 13/474,607

(22) Filed: May 17, 2012

Related U.S. Application Data
(60) Provisional application No. 61/488,735, filed on May 21, 2011.

(51) Int. Cl. A61C 7/30; A61C 7/28

(52) U.S. Cl. 433/11; 433/10

(57) ABSTRACT

A self-ligating bracket with flexible ligating slide includes an archwire slot, a first anterior portion at a first side of the slot, and a second anterior portion at a second side of the slot, the second anterior portion including a primary anterior surface. The bracket includes a first guide and a second guide, with each of the guides extending anteriorly from the primary anterior surface. The slide is movably enclosed between the primary anterior surface, the first guide, and the second guide. At least one of the primary anterior surface, first guide, and second guide includes a curvature in an occlusal-gingival direction. The curvature includes a radius and a center, with the center located to one side of a plane that bisects the slot longitudinally. The plane is perpendicular to a slot bottom wall; and the one side of the plane is the side that includes the second anterior portion.

### CROSS-REFERENCE TO RELATED APPLICATION

This patent document claims the benefit of the filing date of Provisional Application No. 61/488,735, entitled “Self-Ligating Orthodontic Bracket With Flexible Ligating Slide” and filed on May 21, 2011. The entire disclosure of Provisional Application No. 61/488,735 is incorporated into this patent document by reference.

### BACKGROUND OF THE INVENTION

1. Field of the Invention

This invention relates to orthodontic brackets, and in particular, to self-ligating orthodontic brackets.

2. Description of Related Art

Orthodontic brackets are attached to teeth for the purpose of transferring force from wires and other appliances to teeth for the purpose of moving teeth. The new generation of brackets are self ligating, meaning that they have a movable mechanism that can capture (retain) the wire in the bracket slot. These mechanisms are designed such that they generally can engage the wire and force it to the bottom of the bracket slot (active brackets), or form a tube so that the wires can slidably move through the tube (passive brackets).

Active brackets use some of the force provided by the wire to overcome the frictional forces between the wire and the bracket slot, including the slide door. Due to a minimal friction associated with the wires in the passive brackets almost all the force provided by the wires is transferred to the teeth making the tooth movement more efficient. However, since the wires are not forced towards the bottom of the slot by the slot closing mechanism some degree of control over the precise movement of the tooth is lost.

In an effort to address this problem, Orikasa U.S. Pat. No. 6,843,651 proposes providing a ligating slide having curvature in the mesial-distal direction. (See, e.g., FIG. 4 in the Orikasa '651 patent.) While this idea may provide some benefit, there is a need for further improvement.

### SUMMARY OF THE INVENTION

In one aspect of the invention, a self-ligating orthodontic bracket includes an archwire slot, a first anterior portion at a first side of the archwire slot, and a second anterior portion at a second side of the archwire slot, with the second anterior portion including a primary anterior surface. The bracket includes a first guide and a second guide, with each of the first and second guides extending anteriorly from the primary anterior surface of the second anterior portion. A ligating slide is movably enclosed between the primary anterior surface, the first guide, and the second guide. At least one of the primary anterior surface, first guide, and second guide includes a curvature in an occlusal-gingival direction. The curvature includes a radius and a center, with the center of the curvature located to one side of a plane that bisects the archwire slot longitudinally. The plane is perpendicular to an archwire-slot bottom wall; and the one side of the plane is the side that includes the second anterior portion. In this fashion, at least a portion of a leading end of the ligating slide extends into the archwire slot when the ligating slide is in a closed position. In further detail, the portion of the leading end of the ligating slide may extend to a depth in the archwire slot that is about 0.025 inch or less from the bottom wall of the archwire slot. In this way, the leading end may contact a full-size archwire.

In another aspect of the invention, a self-ligating orthodontic bracket includes an archwire slot, a first anterior portion at a first side of the archwire slot, and a second anterior portion at a second side of the archwire slot, with the second anterior portion including a primary anterior surface. The first and second anterior portions are comprised of a first material. The bracket includes a first guide and a second guide, with each of the first and second guides extending anteriorly from the primary anterior surface of the second anterior portion. A flexible, ligating slide is movably enclosed between the first guide and the second guide. The ligating slide comprises a second material having a flexibility at least two times greater than that of the first material. The ligating slide includes a curvature in an occlusal-gingival direction. The curvature includes a center located to one side of a plane that bisects the archwire slot longitudinally. The plane is perpendicular to an archwire-slot bottom wall; and the one side of the plane is the side that includes the second anterior portion. In this manner, at least a portion of a leading end of the ligating slide extends into the archwire slot when the ligating slide is in a closed position. If desired, the ligating slide may be unitary.

In a further aspect of the invention, a self-ligating orthodontic bracket includes an archwire slot, a first anterior portion at a first side of the archwire slot, and a second anterior portion at a second side of the archwire slot, with the second anterior portion including a primary anterior surface. The bracket includes a first guide and a second guide, with each of these guides extending anteriorly from the primary anterior surface of the second anterior portion, and each of these guides including a curvature in an occlusal-gingival direction. A flexible, ligating slide is movably enclosed between the first guide and the second guide. The ligating slide includes a curvature in an occlusal-gingival direction and a curvature in the mesial-distal direction, with the occlusal-gingival curvature of the ligating slide being substantially similar to that of the first and second guides. If desired, the ligating slide may be unitary.

In an additional aspect of the invention, a self-ligating orthodontic bracket includes an archwire slot, a first anterior portion at a first side of the archwire slot, and a second anterior portion at a second side of the archwire slot, with the second anterior portion including a primary anterior surface. The bracket includes a first guide and a second guide, with each of these guides extending anteriorly from the primary anterior surface of the second anterior portion. A flexible, ligating slide is movably enclosed between the first guide and the second guide. The ligating slide includes a curvature in an occlusal-gingival direction, a curvature in a mesial-distal direction, and a trailing end. The bracket further includes a stop surface at the second anterior portion, with the stop surface operable to contact the ligating-slide trailing end when the ligating slide is in a closed position. If desired, the ligating slide may be unitary.

In yet another aspect of the invention, a self-ligating orthodontic bracket includes an archwire slot, a first anterior portion at a first side of the archwire slot, and a second anterior portion at a second side of the archwire slot, with the second anterior portion including a primary anterior surface. The bracket includes a first guide and a second guide, with each of these guides extending anteriorly from the primary anterior surface of the second anterior portion. The archwire slot includes a first sidewall at the first side of the archwire slot, a second sidewall at the second side of the archwire slot, and a bottom wall extending between the first and second sidewalls. A bridge member interconnects the first guide and the second guide, with the bridge member spaced anteriorly from the primary anterior surface. In this fashion, the bridge member, first guide, second guide, and primary anterior surface cooperate to form an enclosed opening. At least a portion of the first guide, second guide, and bridge member are adjacent the archwire-slot second sidewall. A ligating slide is movably enclosed between the primary anterior surface, first guide, second guide, and bridge member.

In yet a further aspect of the invention, a self-ligating orthodontic bracket includes an archwire slot, a first anterior portion at a first side of the archwire slot, and a second anterior portion at a second side of the archwire slot, with the second anterior portion including a primary anterior surface. The bracket includes a first guide and a second guide, with each of these guides extending anteriorly from the primary anterior surface of the second anterior portion. The archwire slot includes a first sidewall at the first side of the archwire slot, a second sidewall at the second side of the archwire slot, and a bottom wall extending between the first and second sidewalls. The ligating slide of the bracket is comprised of a flexible material. Also, the distance between at least a portion of the posterior surface of the ligating slide and the archwire-slot bottom wall is less than about 0.025 inch when the ligating slide is in a closed position.

In yet an additional aspect of the invention, a ligating slide for use with an orthodontic bracket includes a leading end, an oppositely disposed trailing end, a mesial sidewall, a distal sidewall, an anterior surface, and an oppositely disposed posterior surface. The slide is comprised of a flexible material, includes at least one curvature in an occlusal-gingival direction or in a mesial-distal direction, and further includes a top-view projection that is substantially rectangular.

In another aspect, a self-ligating orthodontic bracket includes an archwire slot comprising a first sidewall at a first side, a second sidewall at a second side, and a bottom wall extending between the first and second sidewalls, with the archwire slot having a width. The bracket further includes a first anterior portion at the first side of the archwire slot, a second anterior portion at the second side of the archwire slot, and a ligating slide having a posterior surface. The distance between at least a portion of the posterior surface and the bottom wall is less than about 0.025 inch when the ligating slide is in a closed position. At least a part of the ligating slide is cantilevered from the second anterior portion when the ligating slide is in the closed position. The cantilevered part has a length, with the length of the cantilevered part being not greater than two times the width of the archwire slot.

These and other advantages will become apparent from the accompanying drawings and description of the drawings.

### BRIEF DESCRIPTION OF THE DRAWINGS

The accompanying drawings, which are a part of this specification, illustrate embodiments of the invention. And together with the general description of the invention given above, and the detailed description of the drawings given below, the accompanying drawings explain the principles of the invention.

FIG. 1 is a highly schematic, elevated view of a portion of a row of teeth extending upward from the lower jaw of an orthodontic patient, with self-ligating orthodontic brackets, in accordance with the principles of the invention, mounted to several of the teeth;

FIG. 2 is a perspective view of an embodiment of the self-ligating orthodontic bracket of the invention, with the flexible ligating slide in a closed position whereby an archwire is captured in the archwire slot of the bracket;

FIG. 3 is a perspective view of an embodiment of a flexible ligating slide, in accordance with the principles of the invention;

FIG. 4 is another perspective view of the self-ligating orthodontic bracket of FIG. 2, with the flexible ligating slide being moved toward a closed position;

FIG. 5 is a cross-sectional view of the self-ligating orthodontic bracket of FIG. 2, taken along line 5-5 of FIG. 2;

FIG. 6 shows curved lines that represent the occlusal-gingival curvature of a flexible ligating slide or a guide channel of the present invention, and where those curved lines project onto the opposite sidewall of an archwire slot, as a function of the location of the center of curvature;

FIG. 7 is a perspective view of the self-ligating orthodontic bracket of FIG. 1, with the flexible ligating slide removed; and

FIG. 8 is a perspective view of another embodiment of the self-ligating orthodontic bracket of the invention.

### DETAILED DESCRIPTION OF THE DRAWINGS

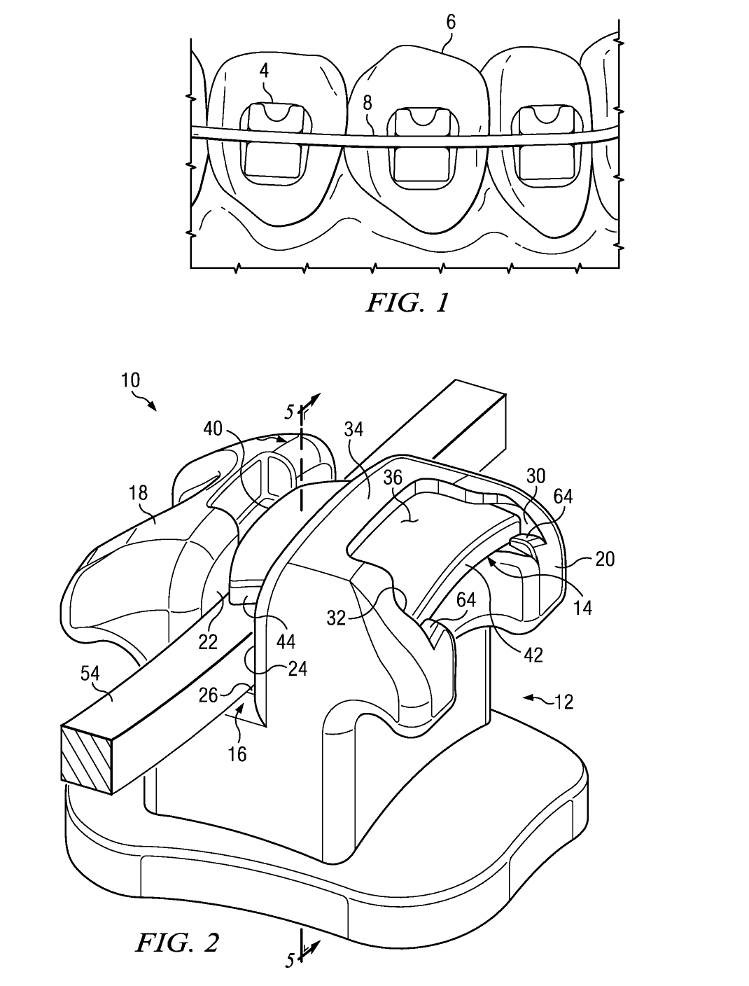

With reference to FIG. 1, several self-ligating orthodontic brackets (as at 4) with flexible ligating slides, in accordance with the principles of the invention, are shown mounted to several teeth (as at 6) extending upward from the lower jaw of an orthodontic patient. In addition, an archwire 8 is at least partially positioned in an archwire slot of each of the several brackets 4.

With reference to FIGS. 2-5 and 7, an exemplary self-ligating orthodontic bracket with a flexible ligating slide 10, in accordance with the principles of the invention, is shown. The bracket 10 includes a bracket body 12 and a flexible ligating slide 14. The bracket body 12 includes an archwire slot 16, a first anterior portion 18 at a first side of the archwire slot 16, and a second anterior portion 20 at a second side of the archwire slot 16. The archwire slot 16 includes a first sidewall 22 at the first side, a second sidewall 24 at the second side, and a bottom wall 26 extending between the first and second sidewalls 22, 24.

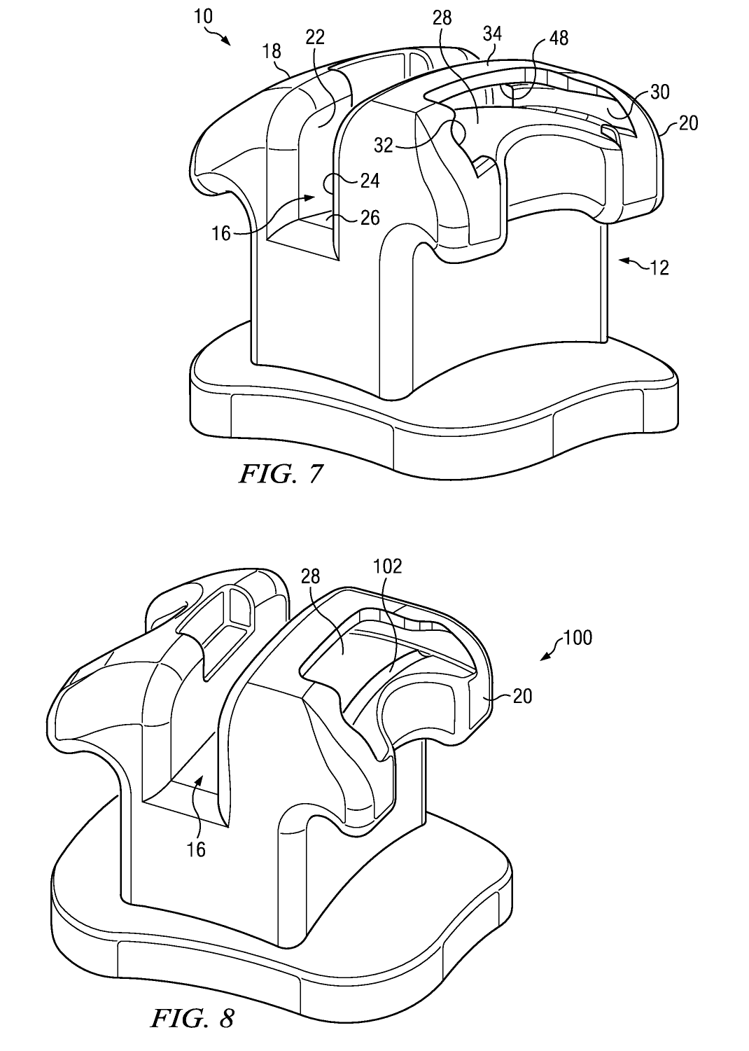

The second anterior portion 20 includes a primary anterior surface 28 (FIG. 7), a first guide in the form of a first guide channel 30 and a second guide in the form of a second guide channel 32 extending anteriorly from the primary anterior surface 28, and a bridge member 34 spaced anteriorly from the primary anterior surface 28 and interconnecting the first and second guide channels 30, 32. Each of the first and second guide channels 30, 32 extends in a generally occlusal-gingival direction, with the channels 30, 32 being laterally spaced from one another in a generally mesial-distal direction. The bridge member 34 extends in a generally mesial-distal direction. The primary anterior surface 28, guide channels 30, 32, and bridge member 34 form an enclosed opening; and the flexible ligating slide 14 is movably enclosed by the enclosed opening.

The flexible ligating slide 14 is movable in a generally occlusal-gingival direction, between an open position (in which an archwire may be inserted into the archwire slot) and a closed position (in which an archwire may be retained or captured in the archwire slot).

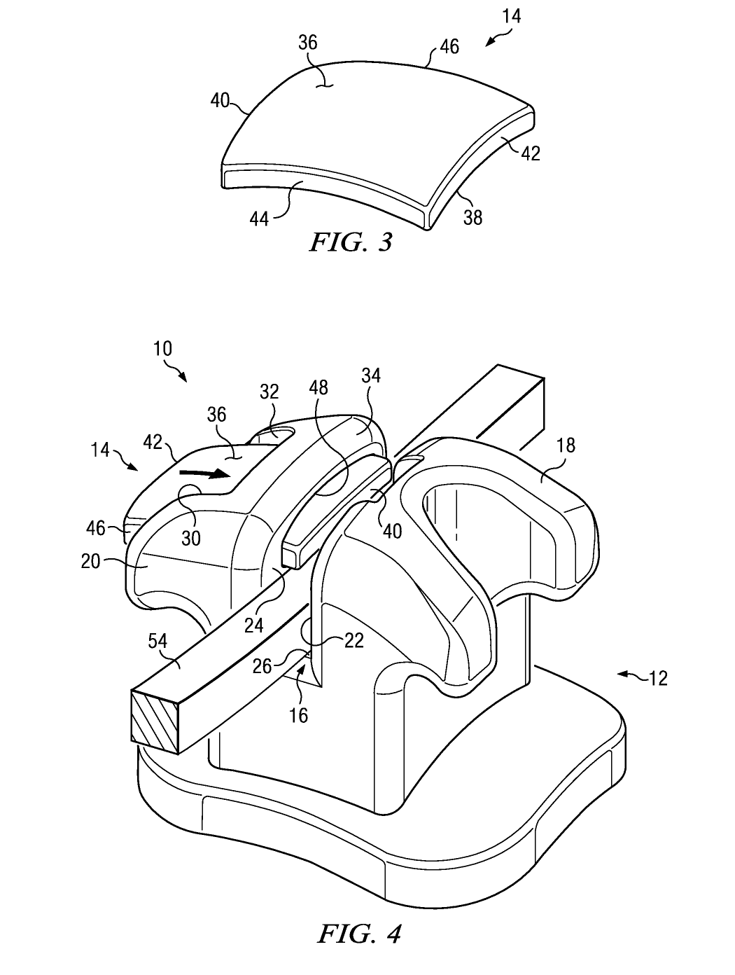

With reference to FIGS. 2-5, the flexible ligating slide 14 includes an anterior surface 36, a posterior surface 38, a leading end 40, a trailing end 42, and first and second sidewalls 44, 46 spaced from one another in a generally mesial-distal direction. As best seen in FIG. 3, the slide 14 has a curvature in the occlusal-gingival direction, as well as a curvature in the mesial-distal direction.

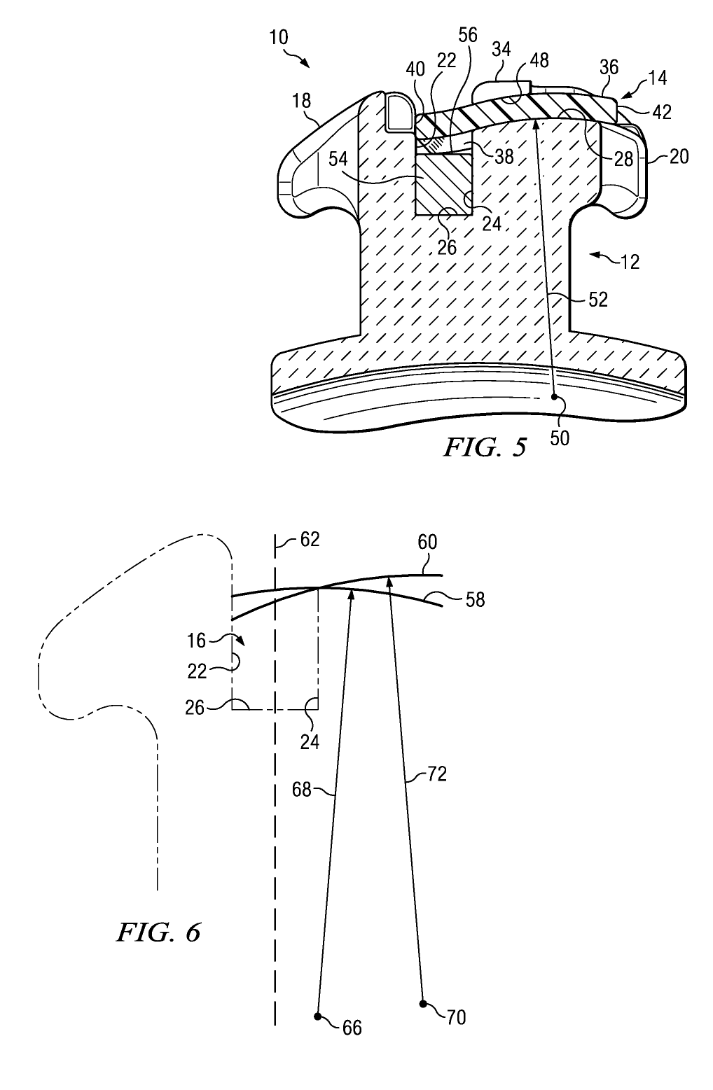

Referring to FIGS. 4, 5, and 7, the primary anterior surface 28, first guide channel 30, second guide channel 32, and posterior-facing surface 48 of the bridge member 34 also have a curvature in both the occlusal-gingival direction and the mesial-distal direction. In FIG. 5, the occlusal-gingival curvature of the primary anterior surface 28 is further identified by the center of curvature 50 and the ray 52 extending from the center 50 to the primary anterior surface 28.

With reference to FIGS. 2 and 5, the flexible ligating slide 14 is in a closed position in which a central portion of the leading end 40 of the slide 14 is contacting the archwire-slot first sidewall 22. In addition, two portions of the posterior surface 38 at the leading end 40 of the slide 14 contact, and are biased against, the archwire 54 present in the archwire slot 16. As may be seen, the distance from these ligating-slide posterior surfaces (as at 56 in FIG. 5) to the archwire-slot bottom wall 26 is less than the distance from the posterior surface 38 of the slide 14 to the archwire-slot bottom wall 26 at the archwire-slot second sidewall 24.

FIG. 6 shows curved lines 58, 60 that represent the occlusal-gingival curvature of a flexible ligating slide or a guide channel of the present invention, and where those curved lines project onto the first sidewall 22 of the archwire slot 16, as a function of the location of the center of curvature. The curved line 58 may be further identified by the center of curvature 66 and the ray 68 extending from the center 66 to the curved line 58. The curved line 60 may be further identified by the center of curvature 70 and the ray 72 extending from the center 70 to the curved line 60. The centers of curvature 66, 70 are located to one side (the right side in FIG. 6) of the plane 62 that bisects the archwire slot 16 longitudinally. The plane 62 is perpendicular to the archwire-slot bottom wall 26; and the one side of the plane 62 is the side that includes the second anterior portion 28 (FIGS. 2, 5, and 7). In this fashion, at least a portion of the leading end of the ligating slide extends downward into the archwire slot 16 when the ligating slide is in a closed position. Accordingly, the distance from the posterior surface of the ligating slide at, or near, the ligating-slide leading end is less than the distance from the posterior surface of the ligating-slide to the archwire-slot bottom wall 26 at the archwire-slot second sidewall 24.

As best seen in FIG. 2, the self-ligating orthodontic bracket 10 has a stop surface feature in the form of a pair of anteriorly-extending protrusions 64, or detents, at the primary anterior surface 28 of the second anterior portion 20. These protrusions 64 releasably maintain the ligating slide 14 in the closed position depicted in FIG. 2, with the trailing end 42 of the slide 14 biased against the protrusions 64.

Referring to FIG. 8, another exemplary self-ligating orthodontic bracket with a flexible ligating slide 100, in accordance with the principles of the invention, is shown. In this particular embodiment 100, the stop surface is in the form of an elongated groove 102 at the primary anterior surface 28 of the second anterior portion 20. The elongated groove 102 is substantially parallel with the archwire slot 16. The groove 102 releasably maintains a ligating slide in a closed position, with the trailing end of the slide engaging the groove.

A self-ligating orthodontic bracket with flexible ligating slide, in accordance with the principles of the invention, may be made using any suitable material(s) and manufacturing technique(s). With regard to materials, the bracket body assembly may be made of type 17-4 PH stainless steel, a translucent aluminum oxide material, or a polymer-based material (i.e., a plastic); and the flexible ligating slide may be made of a titanium alloy, a nickel/titanium alloy, or a polymer-based material (i.e., a plastic). With regard to color, the ligating slide may have a color generally the same as that of the bracket body assembly; or the ligating slide may have a color different from that of the bracket body assembly.

In use, the flexible ligating slide may be moved between open and closed positions. For example, in an open position, the trailing end of the ligating slide is not releasably engaged by the stop surface. Although the slide is removable, the slide is releasably and slidably coupled with the bracket body via contact with one or more of the guides, the primary anterior surface, and the bridge member. In closing the slide, a clinician advances a leading portion of the slide through the enclosed opening or slit. In the closed position, the stop surface releasably engages the trailing end of the slide, thereby assisting in releasably maintaining the slide in the closed position. If desired, the slide may be opened by applying a rearward force to the leading end of the slide, with the force being sufficient to disengage the trailing end of the slide from the stop surface. The first end of the bridge member (i.e., the end substantially coplanar with the second sidewall of the archwire slot), can serve to limit the movement of the slide during the opening process. The flexible ligating slide may be moved between open and closed positions using any suitable technique(s) and/or tool(s). For example, if desired, the slide may be moved using the operating tool 14 disclosed in WIPO Patent Application WO/2009/116560 entitled “Orthodontic Bracket,” filed on Mar. 18, 2009 and published on Sep. 24, 2009. The '560 Patent Application is assigned to DENTSPLY-Sankin K.K., and claims the benefit of the filing date of Japanese Patent Application 2008-069897 filed on Mar. 18, 2008. Both the '560 Application and the '897 Application are incorporated into this patent document by reference.

While the present invention has been illustrated by a description of embodiments, and while the illustrative embodiments have been described in considerable detail, it is not the intention of the inventor to restrict or in any way limit the scope of the following claims to such detail. Additional advantages and modifications readily will appear to those skilled in the art upon a reading of this patent document. The invention, in its broader aspects, is therefore not limited to the specific details, representative apparatus and methods, and illustrative examples shown and described in this patent document. Accordingly, departures may be made from such details without departing from the spirit or scope of the inventor's general inventive concept.

What is claimed is:

1. A self-ligating orthodontic bracket, comprising:
an archwire slot;
a first anterior portion at a first side of the archwire slot;
a second anterior portion at a second side of the archwire slot, the second anterior portion including a primary anterior surface;
a first guide and a second guide, each of the first and second guides extending anteriorly from the primary anterior surface of the second anterior portion;
a ligating slide movably enclosed between the primary anterior surface, the first guide, and the second guide;
at least one of the primary anterior surface, first guide, and second guide including a curvature in an occlusal-gingival direction, the curvature including a radius and a center, the center of the curvature located to one side of a plane that bisects the archwire slot longitudinally, the plane being perpendicular to an archwire-slot bottom wall, the one side of the plane being the side that includes the second anterior portion,
whereby at least a portion of a leading end of the ligating slide extends into the archwire slot when the ligating slide is in a closed position.

2. The self-ligating orthodontic bracket of claim 1 wherein each of the primary anterior surface, first guide, and second guide includes a curvature in an occlusal-gingival direction, each curvature including a radius and a center, the radius of each curvature being substantially similar to that of the other curvatures, and the center of each curvature positioned on or proximate a common axial line.

3. The self-ligating orthodontic bracket of claim 1 wherein at least one of the primary anterior surface, first guide, and second guide includes a curvature in a mesial-distal direction.

4. The self-ligating orthodontic bracket of claim 1 wherein the ligating slide comprises a flexible material.

5. The self-ligating orthodontic bracket of claim 4 wherein the ligating slide flexible material comprises a composition different from that of the bracket first anterior portion and different from that of the bracket second anterior portion.

6. The self-ligating orthodontic bracket of claim 1 further including a bridge member, the bridge member connecting the first guide and the second guide, the bridge member spaced anteriorly from the primary anterior surface, whereby the bridge member, first guide, second guide, and primary anterior surface cooperate to form an enclosed opening through which the ligating slide may move between an open and a closed position.

7. The self-ligating orthodontic bracket of claim 6 wherein the curvature is common to both the first and second guides.

8. The self-ligating orthodontic bracket of claim 6 wherein the bridge member is integral with the first and second guides.

9. The self-ligating orthodontic bracket of claim 1 wherein the ligating slide includes at least one curvature in the occlusal-gingival direction, the ligating slide curvature including a radius less than or equal to the radius of the curvature of the at least one of the primary anterior surface, first guide, and second guide.

10. The self-ligating orthodontic bracket of claim 9 wherein the radius of the ligating slide curvature is within 50 percent of the radius of the at least one of the primary anterior surface, first guide, and second guide.

11. The self-ligating orthodontic bracket of claim 1 further including a stop surface at the second anterior portion, the stop surface operable to contact the ligating slide when the ligating slide is in a closed position, and to facilitate maintaining the ligating slide in the closed position.

12. The self-ligating orthodontic bracket of claim 11 wherein the stop surface includes an elongated groove substantially parallel with the archwire slot.

13. The self-ligating orthodontic bracket of claim 11 wherein the stop surface includes an anteriorly-extending protrusion at the primary anterior surface of the second anterior portion.

14. The self-ligating orthodontic bracket of claim 1 wherein the archwire slot includes a first sidewall at the first side, a second sidewall at the second side, and a bottom wall extending between the first and second sidewalls, wherein the ligating slide includes a leading end and a posterior surface, and wherein, when the ligating slide is in a closed position with at least a portion of the leading end contacting the first sidewall, the distance between at least a portion of the posterior surface of the ligating slide and the bottom wall at the first sidewall is less than the distance between the posterior surface of the ligating slide and the bottom wall at the second sidewall.

15. The self-ligating orthodontic bracket of claim 14 wherein the distance from at least a portion of the posterior surface of the ligating slide to the bottom wall of the archwire slot at the first sidewall is from about 0.015 inch to about 0.030 inch.

16. The self-ligating orthodontic bracket of claim 14 wherein the distance from at least a portion of the posterior surface of the ligating slide to the bottom wall of the archwire slot at the first sidewall is from about 0.015 inch to about 0.025 inch.

17. The self-ligating orthodontic bracket of claim 1 wherein the first guide has an occlusal-gingival curvature, and the second guide has an occlusal-gingival curvature either the same as or different from that of the first guide, wherein the archwire slot includes a first sidewall at the first side, a second sidewall at the second side, and a bottom wall extending between the first and second sidewalls, the second sidewall defining a plane, and wherein the occlusal-gingival curvature of each of the first and second guides intersects the first sidewall at a point that is closer to the bottom wall than the distance between the occlusal-gingival curvature and the bottom wall where the occlusal-gingival curvature intersects the plane of the second sidewall.

18. The self-ligating orthodontic bracket of claim 1 wherein the first and second guides share a common curvature of a first radius in the occlusal-gingival direction, and share a common curvature of a second radius in the mesial-distal direction.

19. The self-ligating orthodontic bracket of claim 1, wherein the bracket includes a bracket body, the bracket body including: the archwire slot, the first anterior portion at a first side of the archwire slot, the second anterior portion at a second side of the archwire slot, the first guide, and the second guide; and wherein the bracket body is comprised of one or more of titanium, aluminum, zirconium, and oxides thereof.

20. The self-ligating orthodontic bracket of claim 1, wherein the ligating slide is comprised of titanium.

21. A self-ligating orthodontic bracket, comprising:
an archwire slot;
a first anterior portion at a first side of the archwire slot;
a second anterior portion at a second side of the archwire slot, the second anterior portion including a primary anterior surface, the first and second anterior portions comprising a first material;
a first guide and a second guide, each of the first and second guides extending anteriorly from the primary anterior surface of the second anterior portion;
a unitary, flexible, ligating slide movably enclosed between the first guide and the second guide, the ligating slide comprising a second material, the second material having a flexibility at least two times greater than that of the first material, the ligating slide further including a curvature in an occlusal-gingival direction, the curvature including a center located to one side of a plane that bisects the archwire slot longitudinally, the plane being perpendicular to an archwire-slot bottom wall, the one side of the plane being the side that includes the second anterior portion,
whereby at least a portion of a leading end of the ligating slide extends into the archwire slot when the ligating slide is in a closed position.

22. A self-ligating orthodontic bracket, comprising:
an archwire slot;
a first anterior portion at a first side of the archwire slot;
a second anterior portion at a second side of the archwire slot, the second anterior portion including a primary anterior surface;
a first guide and a second guide, each of the first and second guides extending anteriorly from the primary anterior surface of the second anterior portion and including a curvature in an occlusal-gingival direction;
a unitary, flexible, ligating slide movably enclosed between the first guide and the second guide, the ligating slide including a curvature in an occlusal-gingival direction and a curvature in the mesial-distal direction, the occlusal-gingival curvature of the ligating slide substantially similar to that of the first and second guides.

23. A self-ligating orthodontic bracket, comprising:
an archwire slot;
a first anterior portion at a first side of the archwire slot;
a second anterior portion at a second side of the archwire slot, the second anterior portion including a primary anterior surface;
a first guide and a second guide, each of the first and second guides extending anteriorly from the primary anterior surface of the second anterior portion;
a unitary, flexible, ligating slide movably enclosed between the first guide and the second guide, the ligating slide including a curvature in an occlusal-gingival direction, a curvature in a mesial-distal direction, and a trailing end;
a stop surface at the second anterior portion, the stop surface operable to contact the ligating-slide trailing end when the ligating slide is in a closed position.

24. A self-ligating orthodontic bracket, comprising:
an archwire slot including a first sidewall at a first side, a second sidewall at a second side, and a bottom wall extending between the first and second sidewalls;
a first anterior portion at the first side of the archwire slot;
a second anterior portion at the second side of the archwire slot, the second anterior portion including a primary anterior surface;
a first guide and a second guide, each of the first and second guides extending anteriorly from the primary anterior surface of the second anterior portion;
a bridge member interconnecting the first guide and the second guide, the bridge member spaced anteriorly from the primary anterior surface, whereby the bridge member, first guide, second guide, and primary anterior surface cooperate to form an enclosed opening, at least a portion of the first guide, second guide, and bridge member adjacent the archwire-slot second sidewall; and
a ligating slide movably enclosed between the primary anterior surface, first guide, second guide, and bridge member.

25. A self-ligating orthodontic bracket, comprising:
an archwire slot including a first sidewall at a first side, a second sidewall at a second side, and a bottom wall extending between the first and second sidewalls;
a first anterior portion at the first side of the archwire slot;
a second anterior portion at the second side of the archwire slot, the second anterior portion including a primary anterior surface;
a first guide and a second guide, each of the first and second guides extending anteriorly from the primary anterior surface of the second anterior portion; and
a ligating slide comprising a flexible material, wherein the distance between at least a portion of the posterior surface of the ligating slide and the bottom wall is less than about 0.025 inch when the ligating slide is in a closed position.

26. A ligating slide for use with an orthodontic bracket, the ligating slide comprising:
a slide including a leading end, an oppositely disposed trailing end, a mesial sidewall, a distal sidewall, an anterior surface, and an oppositely disposed posterior surface;
the slide comprising a flexible material, and at least one curvature in an occlusal-gingival direction or in a mesial-distal direction,
the slide further having a top-view projection that is substantially rectangular.

27. A self-ligating orthodontic bracket, comprising:
an archwire slot including a first sidewall at a first side, a second sidewall at a second side, and a bottom wall extending between the first and second sidewalls, the archwire slot having a width;
a first anterior portion at the first side of the archwire slot;
a second anterior portion at the second side of the archwire slot;
a ligating slide having a posterior surface, wherein the distance between at least a portion of the posterior surface and the bottom wall is less than about 0.025 inch when the ligating slide is in a closed position;
at least a part of the ligating slide cantilevered from the second anterior portion when the ligating slide is in the closed position, the cantilevered part having a length, with the length of the cantilevered part not greater than two times the width of the archwire slot.

28. The self-ligating orthodontic bracket of claim 27 wherein the length of the cantilevered part is not greater than 1.5 times the width of the archwire slot.

29. The self-ligating orthodontic bracket of claim 27 wherein the length of the cantilevered part is not greater than 1.2 times the width of the archwire slot.
